(19) United States
(12) Patent Application Publication
(10) Pub. No.: US 2026/0264758 A1
(43) Pub. Date: Sep. 10, 2026

(54) VEHICLE FRONT STRUCTURE

(71) Applicant: TOYOTA JIDOSHA KABUSHIKI KAISHA, Toyota-shi (JP)

(72) Inventors: Ayaka KAGAMI, Inazawa-shi (JP); Soshiro MURATA, Toyota-shi (JP)

(73) Assignee: TOYOTA JIDOSHA KABUSHIKI KAISHA, Toyota-shi (JP)

(21) Appl. No.: 19/530,611

(22) Filed: Feb. 5, 2026

(30) Foreign Application Priority Data
Mar. 6, 2025 (JP) 2025-035761

(51) Int. Cl. B62D 21/15; B62D 21/02

(52) U.S. Cl. CPC B62D 21/155; B62D 21/02

(57) ABSTRACT

The vehicle front structure includes a skeleton member that is integrally formed by casting and that constitutes a front portion of a vehicle, a front side member that has a rear end portion that is inserted into the skeleton member from a vehicle front side, that extends along a vehicle front-rear direction, and that is provided on a vehicle front side with respect to the skeleton member, and a reinforcement member. The reinforcement member includes an upper portion, a lower portion that is provided to be spaced from the upper portion, a connecting portion that connects the upper portion and the lower portion, a first rib that protrudes from the upper portion and that comes into contact with an inner surface of the front side member, and a second rib that protrudes from the lower portion and that comes into contact with the inner surface of the front side member.

### CROSS-REFERENCE TO RELATED APPLICATION

This application claims priority to Japanese Patent Application No. 2025-035761 filed on March 6, 2025. The disclosure of the above-identified application, including the specification, drawings, and claims, is incorporated by reference herein in its entirety.

### BACKGROUND

### 1. Technical Field

The present disclosure relates to a vehicle front structure.

### 2. Description of Related Art

CN217496274U discloses a vehicle including a body portion that is provided at a front portion of the vehicle and is integrally provided by die casting, a beam that is fitted into a fitting groove formed in the body portion, and a connecting member that is provided in the beam.

### SUMMARY

As in the vehicle disclosed in CN217496274U, it is known that a body portion that is integrally provided and a beam (front side member) that protrudes from the body portion toward a vehicle front side are provided as separate members. In such a vehicle, a connecting member (reinforcement member) may be provided inside the front side member.

In such a configuration, in a case where a load is applied to the vehicle from the front, when a gap is present between the front side member and the reinforcement member provided inside the front side member, it is difficult for an impact to be transmitted from the front side member to the reinforcement member. Therefore, the reinforcement member may not suitably reinforce the front side member, and the front side member may be likely to be lifted or collapsed. In a case where the front side member is lifted or collapses, an impact absorption function of the front side member may not be sufficiently exhibited, and the damage to the vehicle may not be restrained.

The present disclosure has been made in consideration of the above circumstances, and an object thereof is to obtain a vehicle front structure capable of restraining damage to a vehicle.

A vehicle front structure according to a first aspect includes a frame member integrally provided by casting and constituting a front portion of a vehicle, a front side member having an insertion portion fitted into the frame member from a vehicle front side, extending along a vehicle front-rear direction, and provided on the vehicle front side with respect to the frame member, and a reinforcement member provided inside the insertion portion of the front side member, in which the reinforcement member includes a first portion, a second portion provided to be spaced from the first portion, a connecting portion connecting the first portion and the second portion, a first abutting portion protruding from the first portion and abutting an inner surface of the front side member, and a second abutting portion protruding from the second portion and abutting the inner surface of the front side member.

In the vehicle front structure according to the first aspect, the reinforcement member includes the first abutting portion and the second abutting portion that abut the inner surface of the front side member. As a result, for example, in a case where a load is applied to the vehicle from the front, such as a front surface collision of the vehicle, an impact is transmitted from the front side member to the reinforcement member via the first abutting portion and the second abutting portion. Therefore, the reinforcement member can suitably reinforce the front side member, and deformation in which the front side member is bent in an up-down direction or a right-left direction (for example, lifting or collapse) can be restrained. Therefore, the front side member can sufficiently exhibit an impact absorption function. Therefore, the damage to the vehicle (for example, a frame member provided on a vehicle rear side of the front side member) can be restrained.

With a vehicle front structure according to a second aspect, in the first aspect, the first abutting portion protrudes from the first portion toward an upper side, and the second abutting portion protrudes from the second portion toward a lower side.

In the vehicle front structure according to the second aspect, the first abutting portion protrudes from the first portion toward the upper side, and the second abutting portion protrudes from the second portion toward the lower side. As a result, since the first abutting portion and the second abutting portion extend along the up-down direction, deformation in which the front side member is bent in the up-down direction (for example, lifting) can be more suitably restrained. Therefore, the front side member can sufficiently exhibit the impact absorption function. Therefore, the damage to the vehicle can be restrained.

With a vehicle front structure according to a third aspect, in the second aspect,

the front side member includes a partition portion configured to partition a space provided inside the front side member into an upper space and a lower space provided on a lower side of the upper space,

the first portion is provided in the upper space and includes a third abutting portion protruding toward the lower side and abutting the partition portion, and the second portion is provided in the lower space and includes a fourth abutting portion protruding toward the upper side and abutting the partition portion.

In the vehicle front structure according to the third aspect, the first portion includes the third abutting portion that abuts the partition portion. In addition, the second portion includes the fourth abutting portion that abuts the partition portion. As a result, in a case where the load is applied to the vehicle from the front, the impact is transmitted from the front side member to the reinforcement member via the third abutting portion and the fourth abutting portion. Therefore, the reinforcement member can more suitably reinforce the front side member, and the deformation in which the front side member is bent in the up-down direction or the right-left direction (for example, lifting or collapse) can be restrained. Therefore, the front side member can sufficiently exhibit the impact absorption function. Therefore, the damage to the vehicle (for example, the frame member provided on the vehicle rear side of the front side member) can be restrained.

With a vehicle front structure according to a fourth aspect, in the third aspect, further including

a first fastening member configured to fasten the front side member and the first portion of the reinforcement member, and

a second fastening member configured to fasten the front side member and the second portion of the reinforcement member, in which

the first portion includes a first fastening portion fastened to the first fastening member, the second portion includes a second fastening portion fastened to the second fastening member,

the first abutting portion and the third abutting portion are provided at the first fastening portion, and

the second abutting portion and the fourth abutting portion are provided at the second fastening portion.

In the vehicle front structure according to the fourth aspect, the first abutting portion and the third abutting portion are provided at the first fastening portion. In addition, the second abutting portion and the fourth abutting portion are provided at the second fastening portion. As a result, the load transmitted to the reinforcement member can be easily dispersed.

A vehicle front structure according to a fifth aspect includes a frame member integrally provided by casting and constituting a front portion of a vehicle, a front side member having an insertion portion fitted into the frame member from a vehicle front side, extending along a vehicle front-rear direction, and provided on the vehicle front side with respect to the frame member, and a reinforcement member provided inside the insertion portion of the front side member, in which

the front side member includes a partition portion configured to partition a space provided inside the front side member into an upper space and a lower space provided on a lower side of the upper space, and

the reinforcement member includes a first portion provided in the upper space and abutting an inner surface of the front side member and the partition portion, a second portion provided in the lower space and abutting the inner surface of the front side member and the partition portion, and a connecting portion connecting the first portion and the second portion.

In the vehicle front structure according to the fifth aspect, the reinforcement member includes the first portion and the second portion that abut the inner surface of the front side member and the partition portion. As a result, for example, in a case where the load is applied to the vehicle from the front, such as the front surface collision of the vehicle, the impact is transmitted from the front side member to the reinforcement member via the first portion and the second portion. Therefore, the reinforcement member can suitably reinforce the front side member, and the deformation in which the front side member is bent in the up-down direction or the right-left direction (for example, lifting or collapse) can be restrained. Therefore, the front side member can sufficiently exhibit the impact absorption function. Therefore, the damage to the vehicle (for example, the frame member provided on the vehicle rear side of the front side member) can be restrained.

As described above, the vehicle front structure according to the embodiment of the present disclosure has an excellent effect that the damage to the vehicle can be restrained.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a perspective view showing a vehicle front structure according to a first embodiment of the present disclosure;

FIG. 2 is an enlarged view of a main part (2 parts) of FIG. 1 and shows a state in which the front side member is detached from the skeleton member;

FIG. 3 is a perspective view showing a front side member and a reinforcement member according to the first embodiment of the present disclosure;

FIG. 4 is a perspective view showing the front side member according to the first embodiment of the present disclosure;

FIG. 5 is a perspective view showing the reinforcement member according to the first embodiment of the present disclosure;

FIG. 6 is a side view showing the skeleton member and the front side member according to the first embodiment of the present disclosure;

FIG. 7 is a perspective view showing a reinforcement member according to a second embodiment of the present disclosure;

FIG. 8 is a side view showing a skeleton member and a front side member according to the second embodiment of the present disclosure;

FIG. 9 is a perspective view showing a reinforcement member according to a third embodiment of the present disclosure; and

FIG. 10 is a side view showing a skeleton member and a front side member according to the third embodiment of the present disclosure.

### DETAILED DESCRIPTION OF EMBODIMENTS

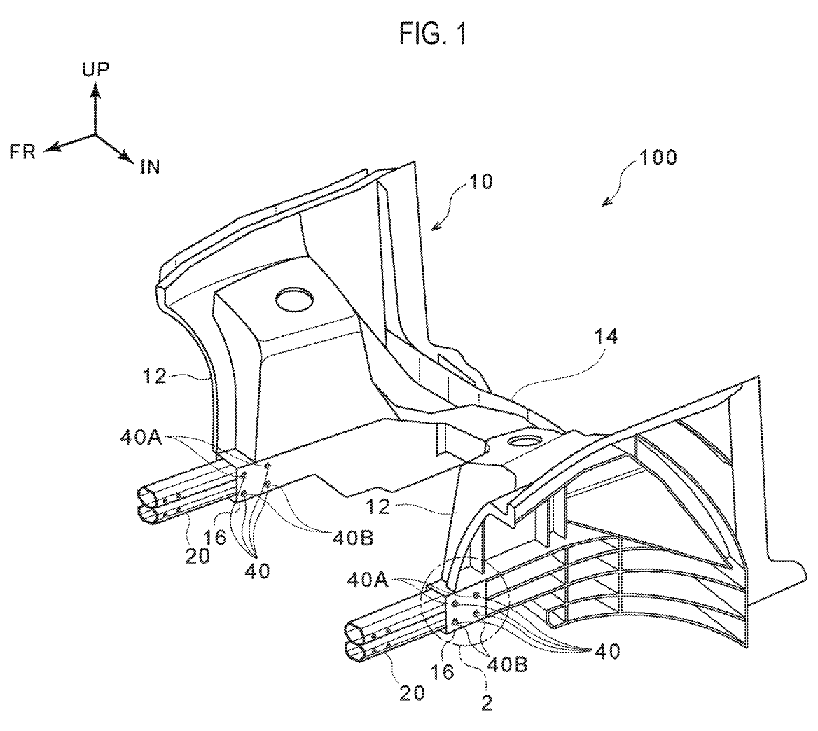

Hereinafter, embodiments of the vehicle front structure according to the present disclosure will be described with reference to FIGS. 1 to 10. In each of the drawings, an arrow FR indicates a vehicle front side that is a front side in a vehicle front-rear direction, an arrow IN indicates an inner side direction in a vehicle width direction, and an arrow UP indicates a vehicle upper side that is an upper side in a vehicle up-down direction. In the following description, in a case where the terms “front-rear direction”, “width direction”, and “up-down direction” are simply used, the terms indicate the vehicle front-rear direction, the vehicle width direction, and the vehicle up-down direction, respectively. In addition, the left-right direction means a left-right direction in a state where the vehicle faces the vehicle front side.

### First Embodiment

The vehicle front structure according to the first embodiment of the present disclosure will be described with reference to FIGS. 1 to 8. The vehicle front structure according to the present embodiment is applied to a vehicle 100.

### Vehicle

The vehicle 100 is, for example, a battery electric vehicle (BEV). The vehicle to which the vehicle front structure according to the present embodiment can be applied is not limited to the BEV. For example, the vehicle front structure according to the present embodiment may be applied to a fuel cell electric vehicle or the like.

### Vehicle Front Structure

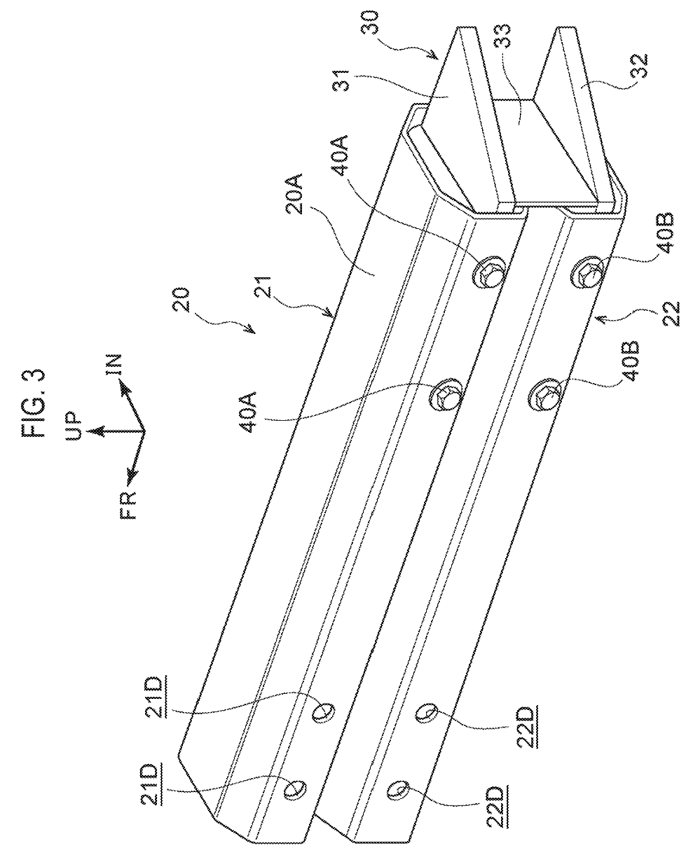

The vehicle front structure according to the present embodiment is provided at a front portion of the vehicle 100. As shown in FIG. 1, the vehicle front structure includes a skeleton member 10, a pair of front side members 20 attached to the skeleton member 10, and a reinforcement member 30 (see FIG. 3) provided inside each front side member 20.

### Skeleton Member 10

The skeleton member 10 constitutes a front portion of the vehicle 100. The skeleton member 10 is a member that forms a skeleton of the front portion of the vehicle 100. The skeleton member 10 is integrally formed by casting. Specifically, the skeleton member 10 is an integrally formed product made of aluminum die casting. The skeleton member 10 integrally includes a pair of front wheel house portions 12, a connecting portion 14 that connects rear portions of the front wheel house portions 12 on the right and left, and a portion to be inserted 16. Here, the portion to be inserted 16 is provided at a lower portion of each front wheel house portion 12 and is inserted into the front side member 20.

The front wheel house portion 12 forms a space in which a front wheel (not shown) is accommodated. The connecting portion 14 connects the pair of front wheel house portions 12 spaced in the vehicle width direction. The connecting portion 14 also serves as a cross member.

The portions to be inserted 16 are provided in a pair to be spaced in the vehicle width direction. Each portion to be inserted 16 is provided at a lower portion of the front wheel house portion 12. A rear end portion of the front side member 20 in the vehicle front-rear direction is inserted into each portion to be inserted 16.

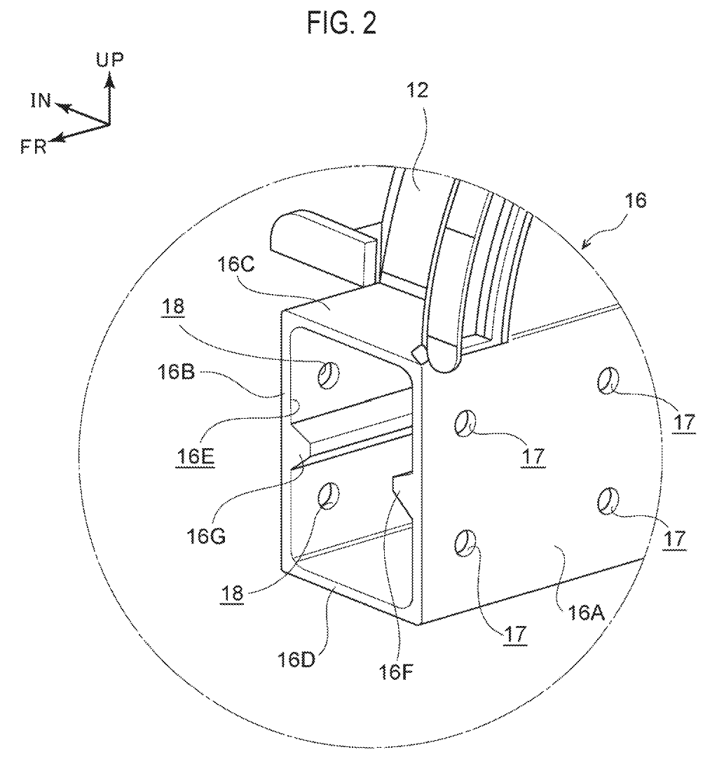

As shown in FIG. 2, the portion to be inserted 16 is provided with a space (hereinafter, referred to as an “inner space”) inside. The portion to be inserted 16 integrally includes an outer wall portion 16A, an inner wall portion 16B that defines an inner end of the inner space in the vehicle width direction, an upper wall portion 16C that defines an upper end of the inner space, and a lower wall portion 16D that defines a lower end of the inner space. The outer wall portion 16A defines an outer end of the inner space in the vehicle width direction. An opening 16E is provided at a front end of the portion to be inserted 16 in the vehicle front-rear direction.

The outer wall portion 16A is a plate-shaped member and is provided such that a plate thickness direction is the vehicle width direction. The outer wall portion 16A is provided with a plurality of (in the present embodiment, four as an example) outer through-holes 17 that penetrate in the plate thickness direction. The outer through-holes 17 communicate the inner space and an external space of the portion to be inserted 16.

An outer protruding portion 16F that protrudes from the inner surface of the outer wall portion 16A is provided on the inner surface. The outer protruding portion 16F is provided at substantially the center of the inner surface of the outer wall portion 16A in the up-down direction and extends linearly along the vehicle front-rear direction. The outer wall portion 16G is inclined such that the upper surface and the lower surface have a length in the up-down direction that decreases from a base end (connection end with the outer wall portion 16A) toward a distal end. A shape of a cross section of the outer protruding portion 16F cut by a surface orthogonal to the vehicle front-rear direction is a trapezoidal shape.

The inner wall portion 16B is a plate-shaped member and is provided such that a plate thickness direction is the vehicle width direction. The inner wall portion 16B is provided to face the outer wall portion 16A. The inner wall portion 16B is provided with a plurality of (in the present embodiment, four as an example) inner through-holes 18 that penetrate in the plate thickness direction. The inner through-holes 18 communicate the inner space and the external space of the portion to be inserted 16.

An inner protruding portion 16G that protrudes from the inner surface of the inner wall portion 16B is provided on the inner surface. The inner protruding portion 16G is provided at substantially the center of the inner surface of the inner wall portion 16B in the up-down direction and extends linearly along the vehicle front-rear direction. The inner protruding portion 16G is inclined such that the upper surface and the lower surface have a length in the up-down direction that decreases from a base end (connection end with the inner wall portion 16B) toward a distal end. A shape of a cross section of the inner protruding portion 16G cut by a surface orthogonal to the vehicle front-rear direction is a trapezoidal shape.

The upper wall portion 16C is a plate-shaped member and is provided such that a plate thickness direction is the up-down direction. A lower end of the front wheel house portion 12 is connected to an upper surface of the upper wall portion 16C. The upper wall portion 16C connects an upper end of the outer wall portion 16A and an upper end of the inner wall portion 16B. A length of the upper wall portion 16C in the vehicle width direction is shorter than a length of the outer wall portion 16A and the inner wall portion 16B in the up-down direction.

The lower wall portion 16D is a plate-shaped member and is provided such that a plate thickness direction is the up-down direction. The lower wall portion 16D is provided to face the upper wall portion 16C. The lower wall portion 16D connects a lower end of the outer wall portion 16A and a lower end of the inner wall portion 16B. A length of the lower wall portion 16D in the vehicle width direction is shorter than a length of the outer wall portion 16A and the inner wall portion 16B in the up-down direction.

The opening 16E is formed at a front end of the portion to be inserted 16 in the vehicle front-rear direction. The opening 16E is open toward a front side in the vehicle front-rear direction. The opening 16E communicates the inner space and the external space of the portion to be inserted 16. The opening 16E has a substantially rectangular shape having the up-down direction as a longitudinal direction and curved four corners as viewed from the vehicle front side. In addition, the outer protruding portion 16F and the inner protruding portion 16G are provided on the inner surface of the portion to be inserted 16. Therefore, as viewed from the vehicle front side, both ends of the opening 16E in the vehicle width direction are recessed at the center in the up-down direction to reduce the length in the vehicle width direction. The front side member 20 is inserted into the portion to be inserted 16 through the opening 16E.

### Front Side Member 20

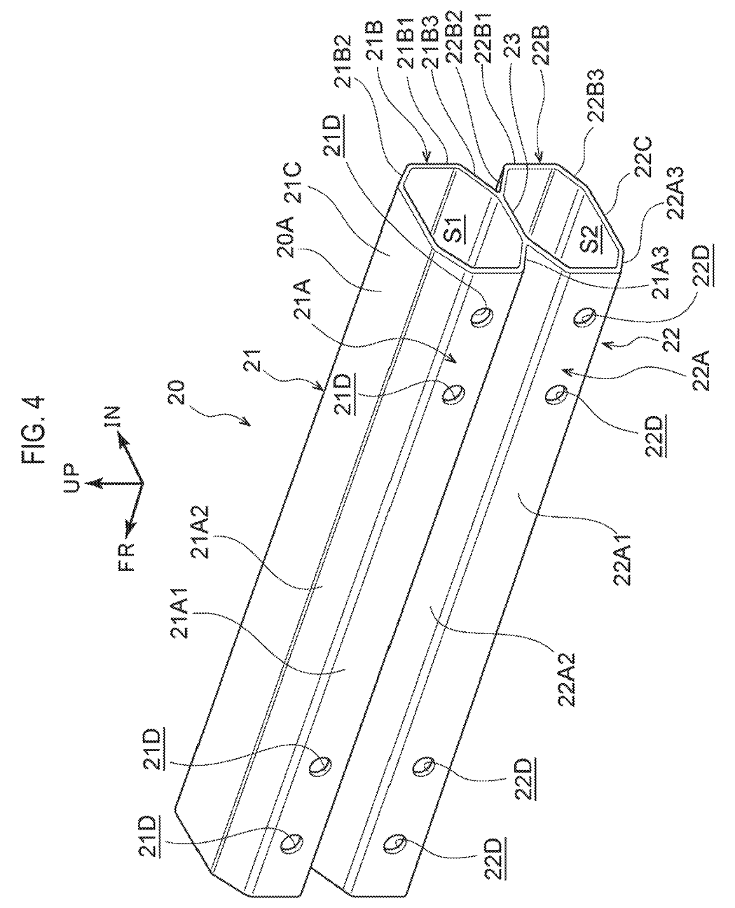

As shown in FIGS. 1, 3, and 4, the front side member 20 extends linearly along the vehicle front-rear direction. The front side member 20 is provided separately from the skeleton member 10. As shown in FIG. 1, the front side member 20 is inserted into the portion to be inserted 16 of the skeleton member 10 from the vehicle front side. Specifically, in the front side member 20, a rear end portion (insertion portion) 20A is inserted into the portion to be inserted 16, and other portions are positioned on the vehicle front side with respect to the skeleton member 10. As shown in FIG. 4, the front side member 20 is provided with a space inside, and openings communicating with the inner space are provided at both end portions in the longitudinal direction. As shown in FIG. 3, the reinforcement member 30 is inserted into the inner space of the front side member 20 from the vehicle rear side.

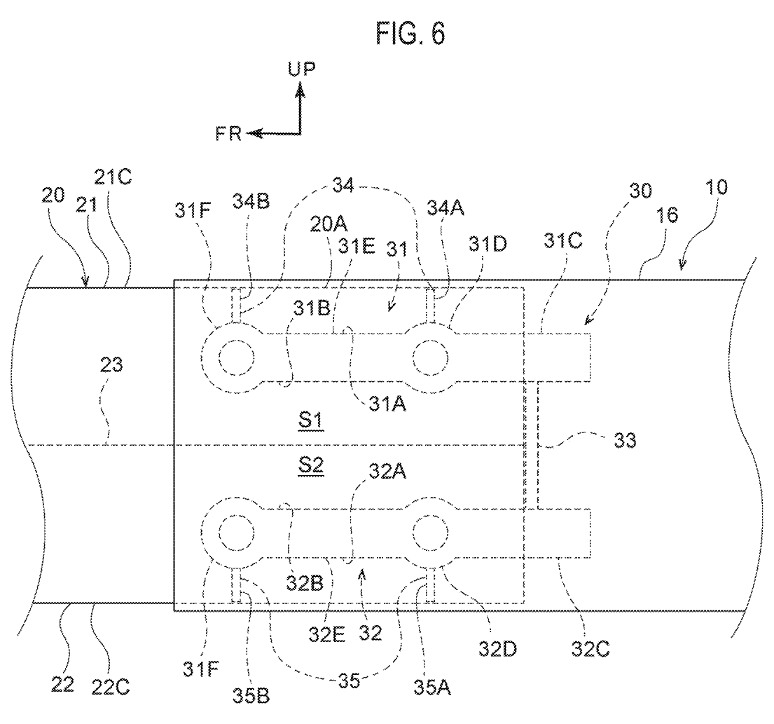

As shown in FIG. 4, in the front side member 20, a shape of a cross section (hereinafter, also simply referred to as a “cross section”) cut by a surface orthogonal to the longitudinal direction (vehicle front-rear direction) is a shape of a number “8”. The inner space of the front side member 20 is partitioned into an upper space S1 and a lower space S2 provided on a vehicle lower side of the upper space S1. As shown in FIG. 6, an upper portion 31 of the reinforcement member 30, which will be described below, is provided in the upper space S1. In addition, a lower portion 32 of the reinforcement member 30 is provided in the lower space S2.

The front side member 20 integrally includes an upper portion 21 that defines the upper space S1, a lower portion 22 that defines the lower space S2, and a partition portion 23 that partitions the upper space S1 and the lower space S2.

The upper portion 21 extends linearly in the vehicle front-rear direction. The upper portion 21 is a tubular member having a substantially octagonal cross section, and has an opening at both end portions in the vehicle front-rear direction. In addition, the upper portion 21 integrally includes an outer wall portion 21A, an inner wall portion 21B that defines an inner end of the upper space S1 in the vehicle width direction, an upper wall portion 21C that defines an upper end of the upper space S1, and a lower wall portion that defines a lower end of the upper space S1. The outer wall portion 21A defines an outer end of the upper space S1 in the vehicle width direction. Since the lower wall portion is the same member as the partition portion 23, a member that defines the lower end of the upper space S1 will be referred to as a “partition portion 23” below.

The outer wall portion 21A is a plate-shaped member and includes a central portion 21A1 that is provided at the center in the up-down direction and has a plate thickness direction in the vehicle width direction, an upper inclined portion 21A2 that is bent from an upper end of the central portion 21A1 and extends upward and toward the inner side in the vehicle width direction, and a lower inclined portion 21A3. The lower inclined portion 21A3 is bent from a lower end of the central portion 21A1 and extends downward and toward the inner side in the vehicle width direction. The central portion 21A1 of the outer wall portion 21A is provided with a plurality of (four as an example in the present embodiment) outer through-holes 21D that penetrate in the plate thickness direction. The outer through-holes 21D communicate the upper space S1 inside the upper portion 21 and an external space of the upper portion 21. Two of the four outer through-holes 21D are provided at a front portion in the vehicle front-rear direction, and the remaining two are provided at a rear portion in the vehicle front-rear direction.

The inner wall portion 21B is a plate-shaped member and includes a central portion 21B1 that is provided at the center in the up-down direction and has a plate thickness direction in the vehicle width direction, an upper inclined portion 21B2 that is bent from an upper end of the central portion 21B1 and extends upward and toward the outer side in the vehicle width direction, and a lower inclined portion 21B3. The lower inclined portion 21B3 is bent from a lower end of the central portion 21B1 and extends downward and toward the outer side in the vehicle width direction. The central portion 21B1 of the inner wall portion 21B is provided with a plurality of (four as an example in the present embodiment) inner through-holes (not shown) that penetrate in the plate thickness direction. The inner through-holes communicate the upper space S1 inside the upper portion 21 and an external space of the upper portion 21. Two of the four inner through-holes are provided at a front portion in the vehicle front-rear direction, and the remaining two are provided at a rear portion in the vehicle front-rear direction.

The upper wall portion 21C is a flat plate-shaped member and is provided such that a plate thickness direction is the up-down direction. The upper wall portion 21C connects an upper end of the outer wall portion 21A and an upper end of the inner wall portion 21B.

The lower portion 22 extends linearly in the vehicle front-rear direction. The lower portion 22 is a tubular member having a substantially octagonal cross section, and has an opening at both end portions in the vehicle front-rear direction. In addition, the lower portion 22 integrally includes an outer wall portion 22A, an inner wall portion 22B that defines an inner end of the lower space S2 in the vehicle width direction, an upper wall portion that defines an upper end of the lower space S2, and a lower wall portion 22C that defines a lower end of the lower space S2. The outer wall portion 22A defines an outer end of the lower space S2 in the vehicle width direction. Since the upper wall portion is the same member as the partition portion 23, a member that defines the upper end of the lower space S2 will be referred to as a “partition portion 23” below.

The outer wall portion 22A is a plate-shaped member and includes a central portion 22A1 that is provided at the center in the up-down direction and has a plate thickness direction in the vehicle width direction, an upper inclined portion 22A2 that is bent from an upper end of the central portion 22A1 and extends upward and toward the inner side in the vehicle width direction, and a lower inclined portion 22A3. The lower inclined portion 22A3 is bent from a lower end of the central portion 22A1 and extends downward and toward the inner side in the vehicle width direction. The central portion 22A1 of the outer wall portion 22A is provided with a plurality of (four as an example in the present embodiment) outer through-holes 22D that penetrate in the plate thickness direction. The outer through-holes 22D communicate the lower space S2 inside the lower portion 22 and an external space of the lower portion 22. Two of the four outer through-holes 22D are provided at a front portion in the vehicle front-rear direction, and the remaining two are provided at a rear portion in the vehicle front-rear direction.

The inner wall portion 22B is a plate-shaped member and includes a central portion 22B1 that is provided at the center in the up-down direction and has a plate thickness direction in the vehicle width direction, an upper inclined portion 22B2 that is bent from an upper end of the central portion 22B1 and extends upward and toward the outer side in the vehicle width direction, and a lower inclined portion 22B3. The lower inclined portion 22B3 is bent from a lower end of the central portion 22B1 and extends downward and toward the outer side in the vehicle width direction. The central portion 22B1 of the inner wall portion 22B is provided with a plurality of (four as an example in the present embodiment) inner through-holes (not shown) that penetrate in the plate thickness direction. The inner through-holes communicate the lower space S2 inside the lower portion 22 and an external space of the lower portion 22. Two of the four inner through-holes are provided at a front portion in the vehicle front-rear direction, and the remaining two are provided at a rear portion in the vehicle front-rear direction.

The lower wall portion 22C is a flat plate-shaped member and is provided such that a plate thickness direction is the up-down direction. The lower wall portion 22C connects a lower end of the outer wall portion 22A and a lower end of the inner wall portion 22B.

The partition portion 23 is a flat plate-shaped member that extends in the vehicle front-rear direction and is provided such that a plate thickness direction is the up-down direction. An upper surface of the partition portion 23 faces the upper space S1. In addition, a lower surface of the partition portion 23 faces the lower space S2. The partition portion 23 connects a lower end of the outer wall portion 21A of the upper portion 21 and a lower end of the inner wall portion 21B. In addition, the partition portion 23 connects an upper end of the outer wall portion 22A of the lower portion 22 and an upper end of the inner wall portion 22B.

### Reinforcement Member 30

As shown in FIGS. 3 and 6, the reinforcement member 30 is provided inside a rear end portion (insertion portion) 20A of the front side member 20 and reinforces the front side member 20. Specifically, a portion of the reinforcement member 30 on the vehicle front side is provided inside the front side member 20, and a portion of the reinforcement member 30 on the vehicle rear side protrudes from the front side member 20. As shown in FIG. 6, a portion protruding from the front side member 20 is provided inside the portion to be inserted 16.

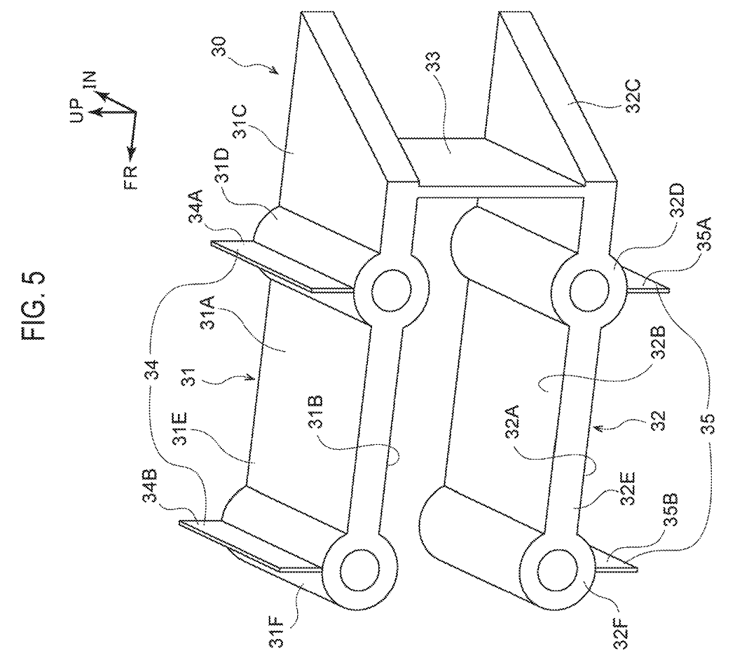

As shown in FIGS. 5 and 6, the reinforcement member 30 includes an upper portion (first portion) 31, a lower portion (second portion) 32, a connecting portion 33, a first rib (first contact portion) 34 that protrudes upward from the upper portion 31, and a second rib (second contact portion) 35 that protrudes downward from the lower portion 32. The upper portion (first portion) 31 of the reinforcement member 30 is provided in the upper space S1 of the front side member 20. The lower portion (second portion) 32 of the reinforcement member 30 is provided in the lower space S2 of the front side member 20. The connecting portion 33 connects the upper portion 31 and the lower portion 32.

The upper portion 31 is a substantially plate-shaped member and is provided such that a plate thickness direction is the up-down direction. The upper portion 31 is provided on a vehicle upper side with respect to the lower portion 32. The upper portion 31 is provided to be spaced from the lower portion 32.

As shown in FIG. 5, the upper portion 31 includes a first outer surface 31A that faces the inner surface of the front side member 20 and a first inner surface 31B that is a surface on a side opposite to the first outer surface 31A. In addition, the upper portion 31 integrally includes an upper connecting portion 31C, a rear side boss portion (first fastening portion) 31D connected to a front end of the upper connecting portion 31C, a flat plate portion 31E, and a front side boss portion (first fastening portion) 31F connected to a front end of the flat plate portion 31E. The upper connecting portion 31C is connected to the connecting portion 33. The flat plate portion 31E is connected to a front end of the rear side boss portion 31D.

The first outer surface 31A and the first inner surface 31B are flat surfaces in the upper connecting portion 31C and the flat plate portion 31E and are curved surfaces (specifically, cylindrical surfaces) in the rear side boss portion 31D and the front side boss portion 31F.

The first outer surface 31A faces a lower surface of the upper wall portion 21C of the upper portion 21 of the front side member 20 in a state where the reinforcement member 30 is provided inside the front side member 20.

The first inner surface 31B faces a second inner surface 32B of the lower portion 32 in a state where the reinforcement member 30 is not provided inside the front side member 20. The first inner surface 31B faces an upper surface of the partition portion 23 in a state where the reinforcement member 30 is provided inside the front side member 20.

The upper connecting portion 31C is plate-shaped and is provided such that a plate thickness direction is the up-down direction. An upper end of the connecting portion 33 is connected to a lower surface (part of the first inner surface 31B) of the upper connecting portion 31C. A rear end portion of the upper connecting portion 31C is formed in a substantially triangular shape in a top view. A rear end of the rear side boss portion 31D is connected to a front end of the upper connecting portion 31C.

The rear side boss portion 31D is a cylindrical member centered on a center axis extending in the vehicle width direction. An upper end portion of the rear side boss portion 31D protrudes upward with respect to an upper end portion of the adjacent upper connecting portion 31C and the flat plate portion 31E. In addition, a lower end portion of the rear side boss portion 31D protrudes downward with respect to a lower end portion of the adjacent upper connecting portion 31C and the flat plate portion 31E. An upper bolt 40A, which will be described below, is inserted into the rear side boss portion 31D. A screw thread (not shown) that is screwed to the upper bolt 40A is formed on an inner peripheral surface of the rear side boss portion 31D. A rear end of the flat plate portion 31E is connected to a front end of the rear side boss portion 31D.

The flat plate portion 31E is plate-shaped and is provided such that a plate thickness direction is the up-down direction. A rear end of the front side boss portion 31F is connected to a front end of the flat plate portion 31E.

The front side boss portion 31F is a cylindrical member centered on a center axis extending in the vehicle width direction. An upper end portion of the front side boss portion 31F protrudes upward with respect to an upper end portion of the adjacent upper connecting portion 31C and the flat plate portion 31E. In addition, a lower end portion of the front side boss portion 31F protrudes downward with respect to a lower end portion of the adjacent upper connecting portion 31C and the flat plate portion 31E. The upper bolt 40A, which will be described below, is inserted into the front side boss portion 31F. A screw thread (not shown) that is screwed to the upper bolt 40A is formed on an inner peripheral surface of the front side boss portion 31F.

The lower portion 32 is a substantially plate-shaped member and is provided such that a plate thickness direction is the up-down direction. The lower portion 32 is provided on a vehicle lower side with respect to the upper portion 31.

The lower portion 32 includes a second outer surface 32A that faces the inner surface of the front side member 20 and a second inner surface 32B that is a surface on a side opposite to the second outer surface 32A. In addition, the lower portion 32 integrally includes a lower connecting portion 32C to which the connecting portion 33 is connected, a front side boss portion (second fastening portion) 32D connected to a front end of the lower connecting portion 32C, a flat plate portion 32E, and a front side boss portion (second fastening portion) 32F. The flat plate portion 32E is connected to a front end of the front side boss portion 32D. The front side boss portion (second fastening portion) 32F is connected to a front end of the flat plate portion 32E.

The second outer surface 32A and the second inner surface 32B are flat surfaces in the lower connecting portion 32C and the flat plate portion 32E and are curved surfaces (specifically, cylindrical surfaces) in the front side boss portion 32D and the front side boss portion 32F.

The second outer surface 32A faces a lower surface of the upper wall portion 21C of the upper portion 21 of the front side member 20 in a state where the reinforcement member 30 is provided inside the front side member 20.

The second inner surface 32B faces the second inner surface 32B of the lower portion 32 in a state where the reinforcement member 30 is not provided inside the front side member 20. The second inner surface 32B faces an upper surface of the partition portion 23 in a state where the reinforcement member 30 is provided inside the front side member 20.

The lower connecting portion 32C is plate-shaped and is provided such that a plate thickness direction is the up-down direction. A lower end of the connecting portion 33 is connected to an upper surface (part of the second inner surface 32B) of the lower connecting portion 32C. A rear end portion of the lower connecting portion 32C is formed in a substantially triangular shape in a top view. A rear end of the front side boss portion 32D is connected to a front end of the lower connecting portion 32C.

The rear side boss portion 32D is a cylindrical member centered on a center axis extending in the vehicle width direction. An upper end portion of the rear side boss portion 32D protrudes upward with respect to an upper end portion of the adjacent upper connecting portion 32C and the flat plate portion 32E. In addition, a lower end portion of the rear side boss portion 32D protrudes downward with respect to a lower end portion of the adjacent upper connecting portion 32C and the flat plate portion 32E. A lower bolt 40B, which will be described below, is inserted into the rear side boss portion 32D. A screw thread (not shown) that is screwed to the lower bolt 40B is formed on an inner peripheral surface of the rear side boss portion 32D. A rear end of the flat plate portion 32E is connected to a front end of the rear side boss portion 32D.

The flat plate portion 32E is plate-shaped and is provided such that a plate thickness direction is the up-down direction. A rear end of the front side boss portion 32F is connected to a front end of the flat plate portion 32E.

The front side boss portion 32F is a cylindrical member centered on a center axis extending in the vehicle width direction. An upper end portion of the front side boss portion 32F protrudes upward with respect to an upper end portion of the adjacent upper connecting portion 32C and the flat plate portion 32E. In addition, a lower end portion of the front side boss portion 32F protrudes downward with respect to a lower end portion of the adjacent upper connecting portion 32C and the flat plate portion 32E. The lower bolt 40B, which will be described below, is inserted into the front side boss portion 32F. A screw thread (not shown) that is screwed to the lower bolt 40B is formed on an inner peripheral surface of the front side boss portion 32F.

The connecting portion 33 is a plate-shaped member and is provided such that a plate thickness direction is the vehicle front-rear direction. An upper end of the connecting portion 33 is connected to a lower surface of the upper connecting portion 31C. In addition, a lower end of the connecting portion 33 is connected to an upper surface of the lower connecting portion 32C. As shown in FIG. 6, in a state where the reinforcement member 30 is inserted into the front side member 20, a front surface of the connecting portion 33 comes into contact with a rear end of the partition portion 23.

As shown in FIGS. 5 and 6, a plurality of (two as an example in the present embodiment) first ribs 34 are provided. The plurality of first ribs 34 includes a rear side first rib 34A that protrudes upward from an upper surface of the rear side boss portion 31D and a front side first rib 34B that protrudes upward from an upper surface of the front side boss portion 31F. Since the rear side first rib 34A and the front side first rib 34B have the same configuration, in the following description, unless otherwise specified, the rear side first rib 34A and the front side first rib 34B will be simply referred to as “first ribs 34”.

The first rib 34 is a flat plate-shaped member and is provided such that a plate thickness direction is the vehicle front-rear direction. As shown in FIG. 6, a distal end (upper end) of the first rib 34 comes into contact with the inner surface of the front side member 20. Specifically, the distal end (upper end) of the first rib 34 comes into contact with a lower surface of the upper wall portion 21C of the upper portion 21 of the front side member 20. A lower end of the first rib 34 is connected to the upper portion 31. The first rib 34 and the upper portion 31 may be an integral body without a joint or may be bodies that are separate from each other and are connected to each other.

As shown in FIGS. 5 and 6, a plurality of (two as an example in the present embodiment) second ribs 35 are provided. The plurality of second ribs 35 includes a rear side second rib 35A that protrudes downward from a lower surface of the rear side boss portion 32D and a front side second rib 35B that protrudes downward from a lower surface of the front side boss portion 32F. Since the rear side second rib 35A and the front side second rib 35B have the same configuration, in the following description, unless otherwise specified, the rear side second rib 35A and the front side second rib 35B will be simply referred to as “second ribs 35”.

The second rib 35 is a plate-shaped member and is provided such that a plate thickness direction is the vehicle front-rear direction. As shown in FIG. 6, a distal end (lower end) of the second rib 35 comes into contact with the inner surface of the front side member 20. Specifically, the distal end (lower end) of the second rib 35 comes into contact with an upper surface of the lower wall portion 22C of the lower portion 22 of the front side member 20. An upper end of the second rib 35 is connected to the lower portion 32. The second rib 35 and the lower portion 32 may be an integral body without a joint or may be bodies that are separate from each other and are connected to each other.

As shown in FIG. 6, the rear end portion 20A of the front side member 20 in a state where the reinforcement member 30 is provided inside is inserted into the portion to be inserted 16 of the skeleton member 10. As described above, a part (a portion on the vehicle front side with respect to the connecting portion 33) of the reinforcement member 30 is provided in a region where the portion to be inserted 16 of the skeleton member 10 and the front side member 20 overlap with each other. That is, a part of the reinforcement member 30 is provided inside both the front side member 20 and the portion to be inserted 16.

### Bolt 40

In addition, the portion to be inserted 16 of the skeleton member 10, the front side member 20, and the reinforcement member 30 are fastened and fixed to each other by a plurality of bolts 40 (see FIG. 1). The plurality of bolts 40 include an upper bolt (first fastening member) 40A provided on the vehicle upper side and a lower bolt (second fastening member) 40B provided on the lower side of the upper bolt 40A.

The upper bolt 40A is inserted into the outer through-hole 17 or the inner through-hole 18 (see FIG. 2) of the portion to be inserted 16, the outer through-hole 21D (see FIG. 4) or the inner through-hole of the upper portion 21 of the front side member 20, or the rear side boss portion 31D or the front side boss portion 31F (see FIG. 5) of the upper portion 31 of the reinforcement member 30. A distal end of the upper bolt 40A is screwed to the rear side boss portion 31D or the front side boss portion 31F.

The lower bolt 40B is inserted into the outer through-hole 17 or the inner through-hole 18 (see FIG. 2) of the portion to be inserted 16, the outer through-hole 22D (see FIG. 4) or the inner through-hole of the lower portion 22 of the front side member 20, or the rear side boss portion 32D or the front side boss portion 32F (see FIG. 5) of the lower portion 32 of the reinforcement member 30. A distal end of the lower bolt 40B is screwed to the rear side boss portion 32D or the front side boss portion 32F.

### Action and Effect

According to the present embodiment, the following effects are exhibited. In the present embodiment, the reinforcement member 30 includes the first rib 34 and the rib 35 that come into contact with the inner surface of the front side member 20. As a result, for example, in a case where a load is applied to the vehicle 100 from the front, such as a front surface collision of the vehicle 100, the impact is transmitted from the front side member 20 to the reinforcement member 30 via the first rib 34 and the rib 35. Therefore, the reinforcement member 30 can suitably reinforce the front side member 20, and the front side member 20 can suppress the deformation (for example, rising or collapse) in which the front side member 20 is bent in the up-down direction or the left-right direction. Therefore, the front side member 20 can sufficiently exhibit the impact absorption function. Therefore, the damage to the vehicle 100 (for example, the skeleton member 10 provided on the vehicle rear side of the front side member 20) can be suppressed.

In the present embodiment, the first rib 34 protrudes upward from the upper portion 31 and protrudes downward from the lower portion 32. As a result, since the first rib 34 and the rib 35 extend along the up-down direction, the front side member 20 can more suitably suppress the deformation (for example, rising) in which the front side member 20 is bent in the up-down direction. Therefore, the front side member 20 can sufficiently exhibit the impact absorption function. Therefore, the damage to the vehicle 100 can be suppressed.

In the present embodiment, the first rib 34 and the second rib 35 are provided at the boss portions (the rear side boss portion 31D, the front side boss portion 31F, the rear side boss portion 32D, and the front side boss portion 32F) to which the bolts 40 are fastened. As a result, the load transmitted from the front side member 20 to the reinforcement member 30 can be easily dispersed.

### Second Embodiment

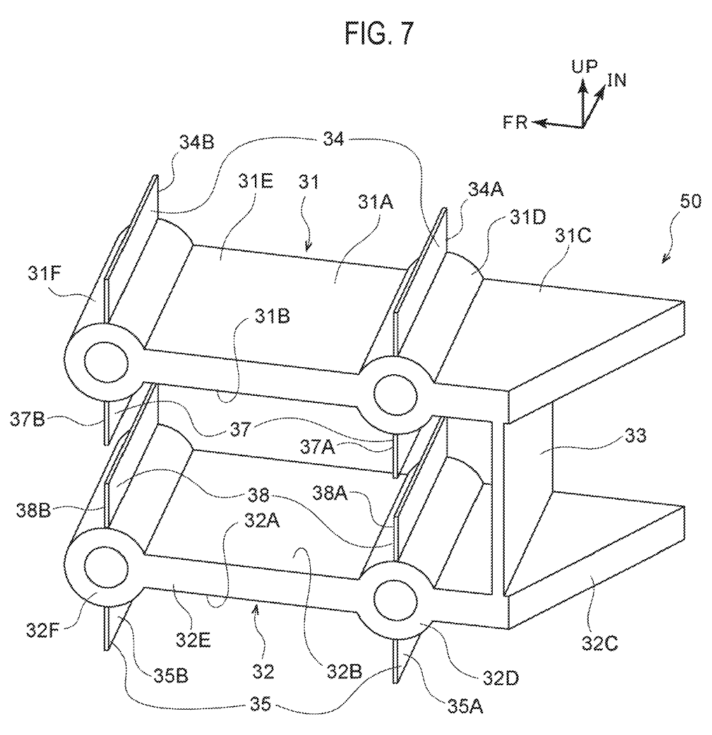

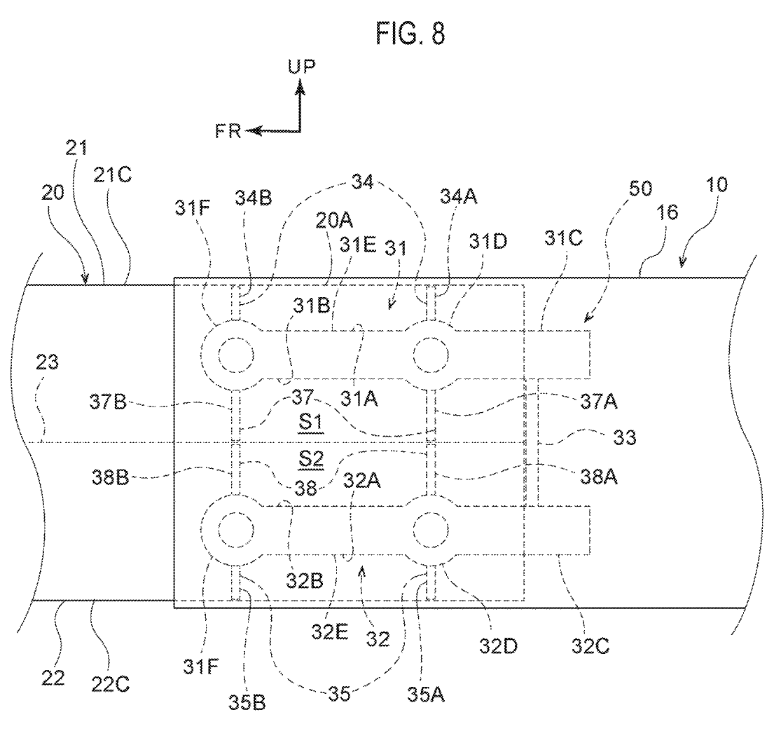

Next, a vehicle front structure according to a second embodiment of the present disclosure will be described with reference to FIGS. 7 and 8. The vehicle front structure according to the present embodiment is different from the vehicle front structure according to the first embodiment only in the structure of the reinforcement member. Therefore, members that are the same as those of the first embodiment will be designated by the same reference numerals and will not be described in detail below.

As shown in FIGS. 7 and 8, a reinforcement member 50 according to the present embodiment includes a third rib (third contact portion) 37 that protrudes downward from the upper portion 31 and a fourth rib (fourth contact portion) 38 that protrudes upward from the lower portion 32.

A plurality of (two as an example in the present embodiment) third ribs 37 are provided. The plurality of third ribs 37 includes a rear side third rib 37A that protrudes downward from a lower surface of the rear side boss portion 31D and a front side third rib 37A that protrudes downward from a lower surface of the front side boss portion 31F. Since the rear side third rib 37A and the front side third rib 37B have the same configuration, in the following description, unless otherwise specified, the rear side third rib 37A and the front side third rib 37B will be simply referred to as “third ribs 37”.

The third rib 37 is a flat plate-shaped member and is provided such that a plate thickness direction is the vehicle front-rear direction. As shown in FIG. 8, a distal end (lower end) of the third rib 37 comes into contact with an upper surface of the partition portion 23.

A plurality of (two as an example in the present embodiment) fourth ribs 38 are provided. The plurality of fourth ribs 38 includes a rear side fourth rib 38A that protrudes upward from an upper surface of the rear side boss portion 32D and a front side fourth rib 38A that protrudes upward from an upper surface of the front side boss portion 32F. Since the rear side fourth rib 38A and the front side fourth rib 38B have the same configuration, in the following description, unless otherwise specified, the rear side fourth rib 38A and the front side fourth rib 38B will be simply referred to as “fourth ribs 38”.

The fourth rib 38 is a flat plate-shaped member and is provided such that a plate thickness direction is the vehicle front-rear direction. As shown in FIG. 8, a distal end (upper end) of the fourth rib 38 comes into contact with a lower surface of the partition portion 23.

According to the present embodiment, the following effects are exhibited. In the present embodiment, the upper portion 31 includes the third rib 37 that comes into contact with the partition portion 23. In addition, the lower portion 32 includes the fourth rib 38 that comes into contact with the partition portion 23. As a result, in a case where a load is applied to the vehicle 100 from the front, the impact is transmitted from the front side member 20 to the reinforcement member 30 via the third rib 37 and the fourth rib 38. Therefore, the reinforcement member 30 can more suitably reinforce the front side member 20, and the front side member 20 can suppress the deformation (for example, rising or collapse) in which the front side member 20 is bent in the up-down direction or the left-right direction. Therefore, the front side member 20 can sufficiently exhibit the impact absorption function. Therefore, the damage to the vehicle 100 (for example, the skeleton member 10 provided on the vehicle rear side of the front side member 20) can be suppressed.

### Third Embodiment

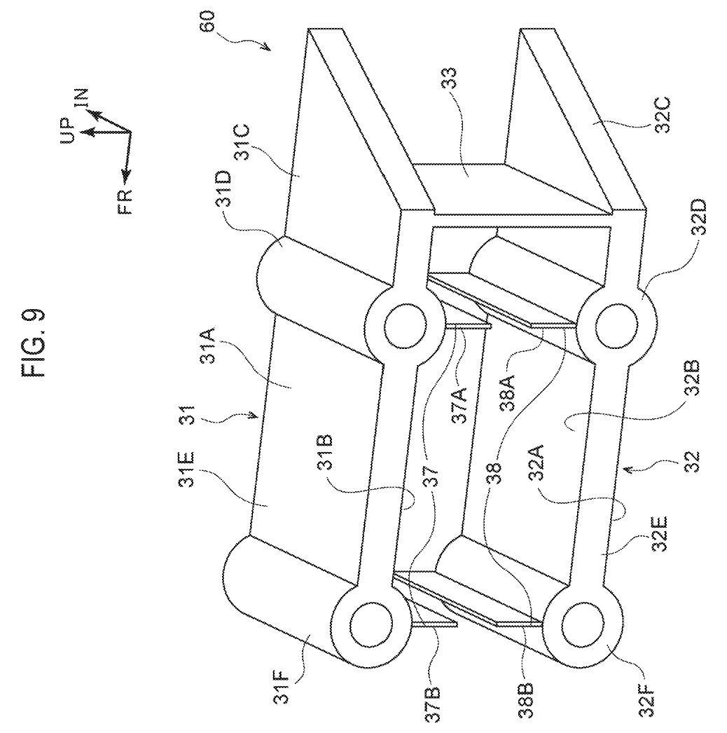

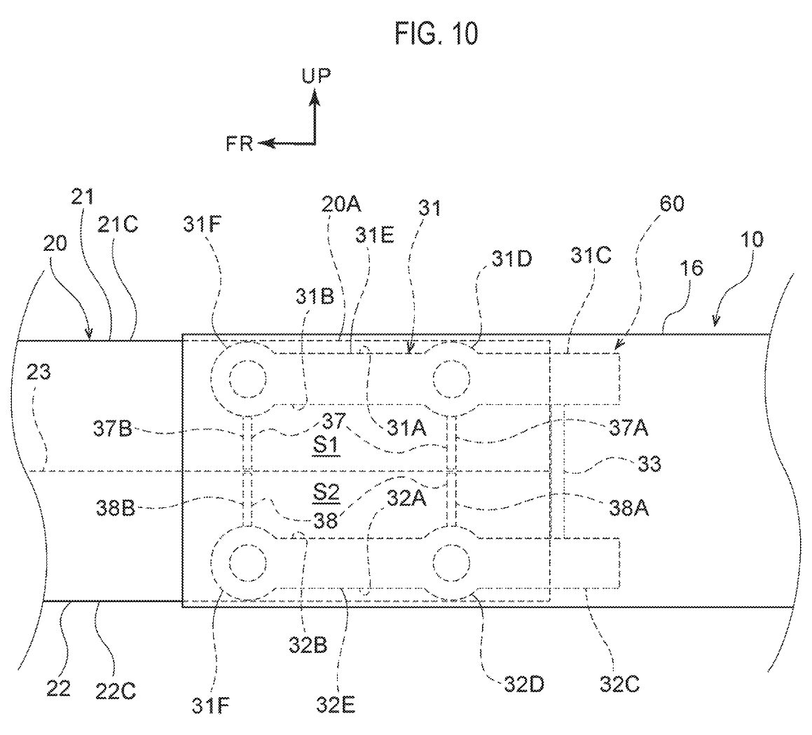

Next, a vehicle front structure according to a third embodiment of the present disclosure will be described with reference to FIGS. 9 and 10. The vehicle front structure according to the present embodiment is different from the vehicle front structure according to the second embodiment only in the structure of the reinforcement member. Therefore, members that are the same as those of the second embodiment will be designated by the same reference numerals and will not be described in detail below.

As shown in FIGS. 9 and 10, in the reinforcement member 60 according to the present embodiment, the first rib 34 is not provided in the upper portion 31. In addition, the second rib 35 is not provided in the lower portion 32.

As shown in FIG. 10, in the reinforcement member 60, the first outer surface 31A of the upper portion 31 comes into contact with the inner surface of the front side member 20. Specifically, the first outer surface 31A of the rear side boss portion 31D and the front side boss portion 31F of the upper portion 31 comes into contact with a lower surface of the upper wall portion 21C of the upper portion 21 of the front side member 20.

In addition, in the reinforcement member 60, the second outer surface 32A of the lower portion 32 comes into contact with the inner surface of the front side member 20. Specifically, the second outer surface 32A of the rear side boss portion 32D and the front side boss portion 32F of the lower portion 32 comes into contact with an upper surface of the lower wall portion 22C of the lower portion 22 of the front side member 20.

According to the present embodiment, the following effects are exhibited. In the present embodiment, the reinforcement member 30 includes the upper portion 31 and the lower portion 32 that come into contact with the inner surface of the front side member 20 and the partition portion 23. As a result, for example, in a case where a load is applied to the vehicle from the front, such as a front surface collision of the vehicle, the impact is transmitted from the front side member 20 to the reinforcement member 30 via the upper portion 31 and the lower portion 32. Therefore, the reinforcement member 30 can suitably reinforce the front side member 20, and the front side member 20 can suppress the deformation (for example, rising or collapse) in which the front side member 20 is bent in the up-down direction or the left-right direction. Therefore, the front side member 20 can sufficiently exhibit the impact absorption function. Therefore, the damage to the vehicle 100 (for example, the skeleton member provided on the vehicle rear side of the front side member 20) can be suppressed.

Although the vehicle front structure according to the embodiment has been described above, the present disclosure can be appropriately changed in design within the scope of the spirit of the present disclosure.

For example, in each of the above-described embodiments, the example has been described in which the rib provided in the upper portion 31 or the lower portion 32 comes into contact with the front side member 20, but the present disclosure is not limited to this. For example, some or all of the ribs (the first rib 34, the second rib 35, the third rib 37, and the fourth rib 38) of the upper portion 31 and the lower portion 32 may not be provided. In this case, some or all of the boss portions (the rear side boss portion 31D, the front side boss portion 31F, the rear side boss portion 32D, and the front side boss portion 32F) of the upper portion 31 or the lower portion 32 may come into contact with the front side member 20. In this case, in each of the boss portions, a portion that protrudes upward or downward with respect to a region (for example, the upper connecting portion 31C, the flat plate portion 31E, the lower connecting portion 32C, and the flat plate portion 32E) other than the boss portions of the upper portion 31 and the lower portion 32 corresponds to the first contact portion, the second contact portion, the third contact portion, and the fourth contact portion.

In addition, in each of the above-described embodiments, the example has been described in which the flat plate-shaped rib is provided in the upper portion 31 or the lower portion 32, but the present disclosure is not limited to this. The member provided in the upper portion 31 or the lower portion 32 need only be able to transfer the load between the reinforcement member 30 and the front side member 20 by coming into contact with the front side member 20. For example, the present disclosure is not limited to this. The member provided in the upper portion 31 or the lower portion 32 may be a plate-shaped member having a triangular shape or a quadrangular shape in a front view, or may be a column or a polygonal column.

In addition, in each of the above-described embodiments, the example has been described in which the rib protrudes from the first outer surface 31A, the first inner surface 31B of the upper portion 31, the second outer surface 32A, or the second inner surface 32B of the lower portion 32, but the present disclosure is not limited to this. For example, the rib may protrude from an inner side surface or an outer side surface of the upper portion 31 in the vehicle width direction. In addition, the rib may protrude from an inner side surface or an outer side surface of the lower portion 32 in the vehicle width direction.

In addition, in each of the above-described embodiments, the example has been described in which each rib is provided in the boss portion (the front side boss portion 31D and the rear side boss portion 31F) of the upper portion 31 or the boss portion (the front side boss portion 32D and the rear side boss portion 32F) of the lower portion 32, but the present disclosure is not limited to this. For example, each rib may be provided to protrude from an upper surface or a lower surface of the upper connecting portion 31C or the flat plate portion 31E of the upper portion 31. In addition, each rib may be provided to protrude from an upper surface or a lower surface of the lower connecting portion 32C or the flat plate portion 32E of the lower portion 32.

In addition, in each of the above-described embodiments, the example has been described in which each rib extends along the vertical up-down direction as viewed in the vehicle width direction, but the present disclosure is not limited to this. For example, each rib may extend to be inclined with respect to the vertical up-down direction as viewed in the vehicle width direction.

In addition, in each of the above-described embodiments, the example has been described in which two first ribs 34, two second ribs 35, two third ribs 37, and two fourth ribs 38 are provided, but the present disclosure is not limited to this. The number of ribs may be singular or plural of three or more.

In addition, in each of the above-described embodiments, the reinforcement member 30 is configured such that the plate thickness direction of the upper portion 31 and the lower portion 32 is the up-down direction in the inner space of the front side member 20, but the present disclosure is not limited to this. The reinforcement member may be configured such that the plate thickness direction of the upper portion 31 and the lower portion 32 is the vehicle width direction in the inner space of the front side member 20.

In addition, in each of the above-described embodiments, the example has been described in which the front side member 20 has a substantially octagonal cross-sectional shape, but the present disclosure is not limited to this. For example, the front side member 20 may have a circular cross-sectional shape or may have a polygonal shape other than an octagonal shape.

In addition, in the above-described embodiment, the example has been described in which the inner space of the front side member 20 is partitioned into the upper space S1 and the lower space S2, but the present disclosure is not limited to this. For example, the inner space of the front side member 20 may be a single space without being partitioned into a plurality of spaces.

In addition, in the above-described embodiment, the example has been described in which the upper portion 21, the lower portion 22, and the partition portion 23 of the front side member 20 are integrally formed, but the present disclosure is not limited to this. For example, the upper portion 21 and the lower portion 22 may be integrally formed, and the partition portion 23 may be separate from the upper portion 21 and the lower portion 22. In addition, the upper portion 21, the lower portion 22, and the partition portion 23 may be separate from each other.

What is claimed is:

1. A vehicle front structure comprising:
a frame member integrally provided by casting and constituting a front portion of a vehicle;
a front side member having an insertion portion fitted into the frame member from a vehicle front side, extending along a vehicle front-rear direction, and provided on the vehicle front side with respect to the frame member; and
a reinforcement member provided inside the insertion portion of the front side member,
wherein the reinforcement member includes a first portion, a second portion provided to be spaced from the first portion, a connecting portion connecting the first portion and the second portion, a first abutting portion protruding from the first portion and abutting an inner surface of the front side member, and a second abutting portion protruding from the second portion and abutting the inner surface of the front side member.

2. The vehicle front structure according to claim 1, wherein:
the first abutting portion protrudes from the first portion toward an upper side; and
the second abutting portion protrudes from the second portion toward a lower side.

3. The vehicle front structure according to claim 2, wherein:
the front side member includes a partition portion configured to partition a space provided inside the front side member into an upper space and a lower space provided on a lower side of the upper space;
the first portion is provided in the upper space and includes a third abutting portion protruding toward the lower side and abutting the partition portion; and
the second portion is provided in the lower space and includes a fourth abutting portion protruding toward the upper side and abutting the partition portion.

4. The vehicle front structure according to claim 3, further comprising:
a first fastening member configured to fasten the front side member and the first portion of the reinforcement member; and
a second fastening member configured to fasten the front side member and the second portion of the reinforcement member, wherein:
the first portion includes a first fastening portion fastened to the first fastening member;
the second portion includes a second fastening portion fastened to the second fastening member;
the first abutting portion and the third abutting portion are provided at the first fastening portion; and
the second abutting portion and the fourth abutting portion are provided at the second fastening portion.

5. A vehicle front structure comprising:
a frame member integrally provided by casting and constituting a front portion of a vehicle;
a front side member having an insertion portion fitted into the frame member from a vehicle front side, extending along a vehicle front-rear direction, and provided on the vehicle front side with respect to the frame member; and
a reinforcement member provided inside the insertion portion of the front side member, wherein:
the front side member includes a partition portion configured to partition a space provided inside the front side member into an upper space and a lower space provided on a lower side of the upper space; and
the reinforcement member includes a first portion provided in the upper space and abutting an inner surface of the front side member and the partition portion, a second portion provided in the lower space and abutting the inner surface of the front side member and the partition portion, and a connecting portion connecting the first portion and the second portion.
